(19) United States
(12) Patent Application Publication
(10) Pub. No.: US 2005/0217557 A1
(43) Pub. Date: Oct. 6, 2005

(54) Advertising display

(75) Inventors: Saul Caetano, Ottawa (CA); Angela Tonary, Ottawa (CA)

Correspondence Address: OGILVY RENAULT LLP, 1981 MCGILL COLLEGE AVENUE, SUITE 1600, MONTREAL, QC, H3A2Y3, CA

(73) Assignees: Saul CAETANO; Angela TONARY

(21) Appl. No.: 11/097,284

(22) Filed: Apr. 4, 2005

(30) Foreign Application Priority Data
Apr. 5, 2004 (CA) 2,459,833

(51) Int. Cl. G09F 17/00

(52) U.S. Cl. 116/28 R; 116/1

(57) ABSTRACT

A rotational display with a rotatably mounted body and mountable on, for example, a motor vehicle window. The display has a body for receiving indicia and a locking mount to prevent theft of the display.

### CROSS REFERENCE TO RELATED APPLICATIONS

This application claims priority from Canadian Patent Application No. 2,459,833, filed Apr. 5, 2004.

### FIELD OF THE INVENTION

The present invention relates to an advertising display device and, more particularly, the present invention relates to rotational advertising surfaces.

### BACKGROUND OF THE INVENTION

Recently, window mounted devices have been found extensively in the marketplace. In particular, the automobile window mounted flags having team indicia thereon have enjoyed significant product success. This is particularly true during, for example, the playoff season in professional hockey. These flag arrangements essentially include a mounting device with a flag pole to which is attached a flag. Initially, when these are purchased they are fairly attractive with the vibrant colors; however, over the course of time, the flag can become somewhat tattered and thus unattractive.

A number of arrangements are known in the art and one example is seen in U.S. Design Pat. No. D476,915 where a window mounted help flag is depicted. In terms of other arrangements, Lund, in U.S. Pat. No. 6,178,676, issued Jan. 30, 2001 provides for a warning device for use with vehicles. The arrangement includes a window engaging frame to which is affixed an orange fluorescent material in the shape of a warning sign.

U.S. Pat. No. 5,613,799, issued Mar. 25, 1997 to Guide provides for a further variation on a safety device where the Patentee teaches a rotating flash device and a method of using the same. The arrangement includes a variety of rotatably mounted reflective flags.

Lorenzana et al., in U.S. Pat. No. 6,609,476, issued Aug. 26, 2003 provides for an antennae mounted flag for mounting the flag to the antennae of a vehicle.

A sign holder support is set forth in U.S. Pat. No. 4,776,116, issued Oct. 11, 1988 to Shuman, where the sign holder provides a specific lock device.

Finally, Sawyer, in U.S. Pat. No. 5,953,841, issued Sept. 21, 1999 provides a wind-driven rotatable display where a plurality of flat panels including graphics are rotatably mounted to a support member so that the sign can rotate with fluctuating air currents.

Although the devices that have been established in the prior art are meritorious, such articles are generally expensive for the consumer to purchase and, in most instances, are quite straightforward to steal. Further, in the situation where the indicia becomes faded or otherwise unattractive or unreadable, this involves a significant restructuring of the article or, in some instances, the article needs to be completely discarded and a new article purchased.

It would be desirable to provide an advertising display which provided the opportunity for relatively straightforward and inexpensive removal of the indicia and a locking arrangement which prevented unauthorized removal or theft of the article. The present invention addresses these needs in the art.

### SUMMARY OF THE INVENTION

One object of one embodiment of the present invention is to provide an improved advertising or display device which is not susceptible to theft.

A further object of one embodiment of the present invention is to provide a rotational display, comprising:

a body for receiving indicia, the body having an elongated central section with a passage;

an elongate support member for rotatably mounting the body, the support member having a first end and a second end opposed thereto;

stop means fixedly secured at the first end of the support member for preventing disengagement of the body from the support member during rotation;

mounting means for mounting the support member to an automobile window;

lock means for releasably locking the elongate support member into the mounting means and accessible from an interior surface of the window;

first cooperating engagement means on the second end of the elongate support member; and

second cooperating engagement means in the mounting means configured for releasable locking engagement with the first cooperating engagement means, whereby when the first cooperating engagement means and the second cooperating engagement means are engaged, unauthorized removal of the display from the window is prevented.

Aesthetically, the arrangement according to the present invention is pleasing since the body is visible from 360° due to the rotation aspect. Further, no movement of the body is required for visibility. In contrast, flag arrangements when the flag is under tension, such as from exposure to wind or other movement, present indicia visible only from the sides.

The body may be composed of any number of materials including polyurethane foam, polyester, high impact polystyrene, polyvinyl fluoride or other foamed or non-foamed suitable plastic materials. These may also include additives to prevent premature degradation of the plastic, such as UV stabilizers, pigment stabilizers, infra red stabilizers inter alia.

In terms of the mounting means and elongate support, these may comprise polyethylene or any other suitable plastic well known in the art for molding articles.

In respect of the indicia, the indicia may comprise silk screening, or may include a combination of silk screening and embossed or projecting characters for the selected indicia. It is also envisioned that the body may include auxiliary lighting or provide on the body itself fluorescent paint or other suitable specialty materials for providing appealing visual effect.

In accordance with a further object of one embodiment of the present invention there is provided a rotational display, comprising:

a body for receiving indicia, the body having an elongated central section with a passage;

an elongate support member for rotatably mounting the body, the support member having a first end and a second end opposed thereto;

stop means fixedly secured at the first end of the support member for preventing disengagement of the body from the support member during rotation;

mounting means for mounting the support member to an automobile window;

an indicia bearing member for removable mounting to the body; and

means for preventing unauthorized removal of the indicia bearing member from the body.

Advantageously, by providing a removable indicia bearing member, one can collect such indicia bearing members in the case, for example, where the indicia member is depicting a specific sports team. In terms of the indicia bearing member, any suitable material which is flexible may be employed. This will include either textile material or non-textile material or a combination of the two. As examples, the bearing member may be composed of cotton, spandex, and a polymeric film together with an elastic material to permit positioning about the body of the support member.

Conveniently, the provision for the lock prevents unauthorized removal of the device from the vehicle which, in turn, obviates the requirement for the user having to continuously re-purchase new equipment.

Having thus generally described the invention, reference will now be made to the accompanying drawings, illustrating preferred embodiments.

### BRIEF DESCRIPTION OF THE DRAWINGS

FIG. 1 is a perspective view of one embodiment of the present invention;

FIG. 2 is a side elevational view of FIG. 1;

FIG. 3 is a schematic illustration of the article in situ;

FIG. 4 is a cross-sectional view along line 4-4 of FIG. 1;

FIGS. 4A and 4B are variations of FIG. 4;

FIG. 5 is an exploded illustration of a further embodiment of the present invention; and

FIG. 6 is a perspective view of an alternate embodiment of the display body.

Similar numerals denote similar elements.

### DETAILED DESCRIPTION OF THE PREFERRED EMBODIMENTS

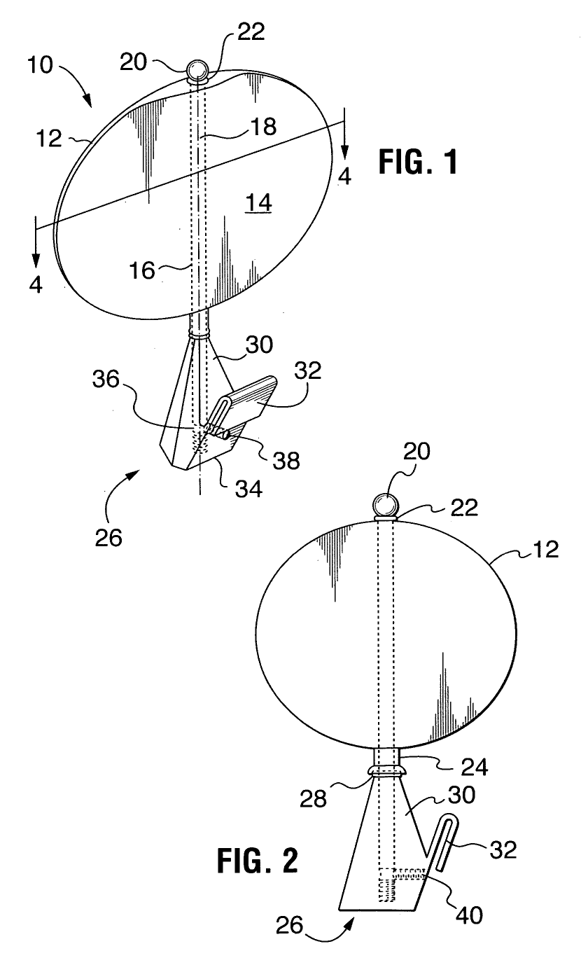

Referring now to the drawings, the overall display device is globally denoted by numeral 10 in FIG. 1 and includes a body 12 having opposed major faces with one of the faces shown in FIG. 1 and denoted by numeral 14. The major faces may include indicia (not shown) directly thereon or may be included by an auxiliary member to be discussed hereinafter. The body may be composed of any suitable material which is stabilized against UV damage, infra red damage, weather extremes, pollution and impact of small articles. Any suitable material achieving these results may be employed and such materials include various members of the polyester, polystyrene and other such materials which may be foamed or non-foamed materials. The body 12, shown in the example as a generally circular article, includes an elongated aperture 16 extending down through the entire body 12. The elongated aperture 16 accommodates an elongate support 18 in the form of a rod, which permits rotational movement of body 12 about rod 18.

Advantageously, the device 10 includes a stop member 20 which is fixedly secured to a first end of the elongate support 18. Stop 20 participates with a series of other components to be discussed hereinafter to prevent removal of body 12 from support 18. As an option, body 12 may include a reinforcement 22, shown best in FIG. 2, for preventing premature wear at the contact point between body 12 and stop 20. By making the provision of the reinforcement 22, not only is rotational guidance achieved, but also the wear that will be experienced during rotation, from frictional forces etc., will be prevented from damaging the body 12 at the point of contact.

Stop 20 is shown in the example as a spherical member; however, it will be appreciated that any shape for the stop may be employed provided that it keeps the function noted above.

In opposition to stop 20 there may be an extension 24 provided on body 12 which effectively spaces the body 12 from the mounting device globally denoted by 26. The mounting device 26 may also include a reinforcement 28 achieving a similar function to that indicated for element 22 noted above.

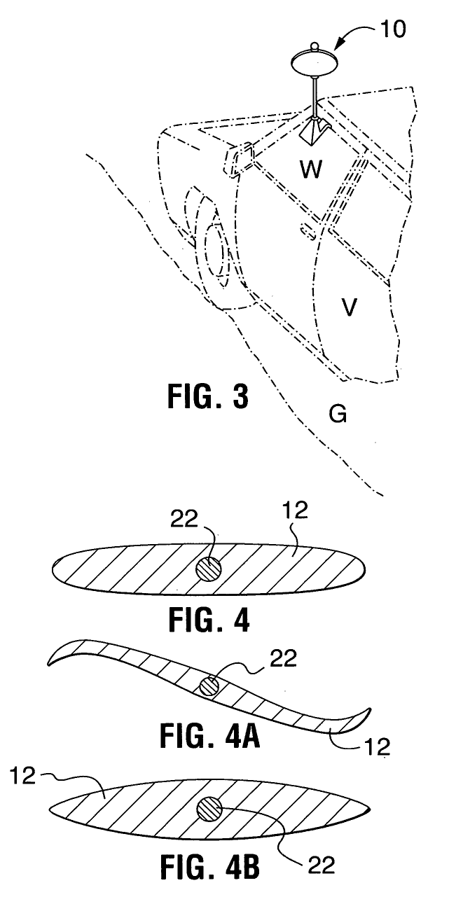

The mounting device 26 comprises a body 30 of rigid material and includes integral therewith a clip 32 of the U-shaped variety. The clip 32 is presented at an angular disposition relative to the body 28, such that when the clip 32 is engaged with a window W of a vehicle V the elongate support member and body are in a substantial vertical attitude, i.e., perpendicular to the ground G. This is illustrated in FIG. 3 of the drawings. The body 30 of the mounting device 26 is configured to receive a portion of the elongate support member, which prevents undo flexure when the device is in use or exposed to airflow at a high velocity. This imparts strength and rigidity to the overall structure, and the body 30 can be dimensioned to accept anywhere from 20% to 80% of the entire length of the elongate support 18.

As a particular advantage to the structure 10, the device includes a locking arrangement which cooperates with the stop 20 to prevent unauthorized removal.

As is illustrated in FIGS. 1 and 2, the elongate support 18 includes a threaded portion 34 which is threadably received within body 30. In addition, the elongate member 18 directly adjacent the threaded portion 34 includes an annular groove 36. In order to inhibit unauthorized removal, body 30 includes an elongate aperture 38 within which is disposed a removable screw 40, shown best in FIG. 2, which screw 40 abuts annular groove 36. In view of the fact that the groove 40 may only be accessed from an inside surface of the window which, of course, is only available by either being positioned within the vehicle V or by having the window W down or the vehicle door open, it is evident that the body 14 which may bear indicia cannot be removed from the elongate member 18. As indicated earlier, stop 20 is fixedly secured and integral with elongate support 18 and, as such, in order to remove body 12 from the support one must initially release screw 40 from contact with the annular groove 36 and subsequently rotate the elongate support 18 out of engagement with body 30. At this point, the elongate support can be withdrawn from within body 12 and body 12 replaced by reinserting the elongate member 18 through the body, threadably engaging the member 18 with body 30, and reinserting screw 40 to contact annular groove 36 of member 18, together with the threaded engagement within body 30, namely by the threaded sections 34 and 38 cooperating to function as a lock to prevent unauthorized removal of the article 10 from window W.

The body 12 preferably has an aerodynamic profile for assisting the rotational motion when the same is exposed to airflow, as would be the case when one is driving with the device 10 attached to the window of the vehicle. To this end, in the example shown in FIGS. 1 through 3, the profile taken in cross-section along line 4 of FIG. 1 is substantially ellipsoidal. This is exemplary; FIGS. 4A and 4B illustrate various other possibilities for the profile of body 12 and this will entirely depend upon the intended use of the article. FIG. 4A, for example, shows a generally propeller shaped cross-section, whereas FIG. 4B illustrates a prolated ellipsoidal shape.

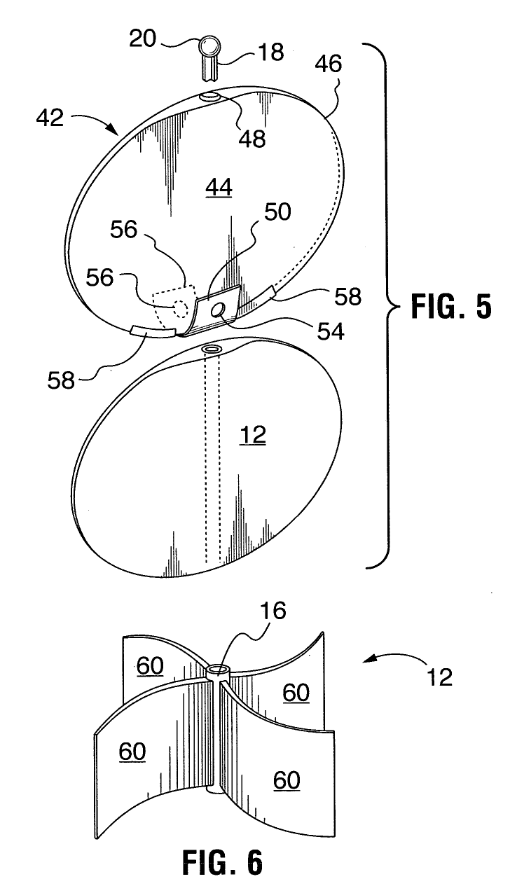

Referring now to FIG. 5, shown is an exploded representation of a further embodiment of the present invention. In the illustration of the embodiment of FIG. 5, the mounting device 30 has been removed for clarity purposes.

In the embodiment shown in FIG. 5, the indicia is applied to body 12 by an indicia bearing member 42. Member 42 comprises a body of flexible material which may be of the textile variety and which is positioned over the top of body 12. In this manner, member 42 is effectively supported by and retained on body 12. It will be appreciated by those skilled in the art that the material of member 42 may comprise any single material or a combination of materials. Examples of suitable materials include elasticized cotton, spandex, polyester, nylon, inter alia. The indicia bearing member may include a first major face 44 and a rearward major face (not shown) with an elastic type material 46 joining the faces.

In order to provide the convenient antitheft features attributable to the embodiment of FIGS. 1 through 3, the indicia bearing member 42 includes a reinforcement member 48 integrally sewn or otherwise attached to the material. In cooperation with the reinforcement 48, the opposed end of the member 42 includes a pair of integrally sewn flaps 50 and 52 each having an aperture 54 and 56, respectively, therethrough. In order to position body 42 over the body 12, the area adjacent flaps 50 and 52 will preferably include some form of releasable engagement for providing a large enough opening to spread the indicia bearing member over the top of the body 12. To this end, suitable Velcro™ strips, denoted by numeral 58, may flank the flaps 50 and 52. Other suitable fasteners include zippers, snaps etc. The objective of the releasably engageable portions 58 is to simply facilitate positioning of indicia bearing member 42 over body 12.

In order to achieve the anti-theft provision, elongate support member with stop 20 may be positioned adjacent to reinforcement 48. In order to facilitate connection of the member 42 to the bottom portion of body 12, the flaps 50 and 52 may simply be folded onto one another so that the apertures 54 and 56 register and the elongate support simply pass therethrough for threaded engagement with mounting device 26 as has been discussed with respect to FIG. 1. In this manner, once the elongate member is engaged, the only way to remove the collectable indicia bearing member 42 is to effectively destroy the material, which, of course, defeats the purpose of pilfering the article from the outset.

FIG. 6 illustrates a perspective view of a further variation of the body 12. In the example, the body 12 provides a plurality of blades 60, depicted as four in quantity. The blades each have an arcuate shape which is useful to capture wind in use. The blades are fixedly secured to member 16. Diametrically opposed blades have oppositely directed curvation.

As alternatives, the indicia bearing member 42 may include reflective tape (not shown) or comprise a variety of different materials stitched together to result in a multi-colored arrangement. It is also envisioned that the indicia bearing support member 42 could include embroidery or a combination of embroidery with silk screening for different purposes as being representative of various sports teams or for commemorative events, general advertising etc. To this end, fluorescent paint or other applique may be employed.

In respect of the locking device that has been discussed herein, it will be appreciated that the example provided in the text is exemplary; any number of suitable locking arrangements operating substantially with the same principle could be employed.

Although embodiments of the invention have been described above, it is not limited thereto and it will be apparent to those skilled in the art that numerous modification form part of the present invention insofar as they do not depart from the spirit, nature and scope of the claimed and described invention.

1. A rotational display, comprising:
a body for receiving indicia, said body having an elongated central section with a passage;
an elongate support member for rotatably mounting said body, said support member having a first end and a second end opposed thereto;
stop means fixedly secured at said first end of said support member for preventing disengagement of said body from said support member during rotation;
mounting means for mounting said support member to an automobile window;
lock means for releasably locking said elongate support member into said mounting means and accessible from an interior surface of said window;
first cooperating engagement means on said second end of said elongate support member; and
second cooperating engagement means in said mounting means configured for releasable locking engagement with said first cooperating engagement means, whereby when said first cooperating engagement means and said second cooperating engagement means are engaged, unauthorized removal of said display from said window is prevented.

2. The display as set forth in claim 1, wherein said display includes spacer means for spacing said body from said mounting means.

3. The display as set forth in claim 1, wherein said stop means is integral with said elongate support member.

4. The display as set forth in claim 1, wherein said body has an aerodynamic profile for aiding rotation when exposed to air flow.

5. The display as set forth in claim 4, wherein said profile is elliptical in transverse cross section relative an axis of rotation.

6. The display as set forth in claim 5, wherein said body is contoured.

7. The display as set forth in claim 1, wherein said mounting means comprises a supporting body and receives a portion of said elongate support member sufficient to prevent flexure of said elongate support member.

8. The display as set forth in claim 7, wherein said mounting means includes a substantially U shaped clip configured for engagement with said window.

9. The display as set forth in claim 7, wherein said clip is angularly inclined relative to said supporting body of said mounting means for positioning said elongate support member in a vertical attitude.

10. The display as set forth in claim 7, wherein said second cooperating engagement means comprises an elongate threaded aperture extending through said supporting body and a screw within said aperture.

11. The display as set forth in claim 10, wherein said first cooperating engagement means comprises a groove at said second end for seating said screw of said second cooperating engagement means.

12. The display as set forth in claim 7, wherein said elongate support member comprises a rod.

13. The display as set forth in claim 12, wherein said portion of said elongate support member within said supporting body comprises between 20% and 80% of said elongate support member.

14. A rotational display, comprising:
a body for receiving indicia, said body having an elongated central section with a passage;
an elongate support member for rotatably mounting said body, said support member having a first end and a second end opposed thereto;
stop means fixedly secured at said first end of said support member for preventing disengagement of said body from said support member during rotation;
mounting means for mounting said support member to an automobile window;
an indicia bearing member for removable mounting to said body; and
means for preventing unauthorized removal of said indicia bearing member from said body.

15. The display as set forth in claim 14, wherein said indicia bearing member comprises a flexible material cover for covering said body for displaying said indicia.

16. The display as set forth in claim 15, wherein said flexible material cover includes said means for preventing unauthorized removal of said indicia bearing member from said body.

17. The display as set forth in claim 15, wherein said means for preventing unauthorized removal of said indicia bearing member from said body comprises a reinforced aperture.

18. The display as set forth in claim 17, wherein said reinforced aperture cooperates with said stop means to prevent unauthorized removal of said flexible material cover.

19. The display as set forth in claim 17, wherein said flexible material cover includes an opening sufficiently dimensioned to facilitate positioning of said material over said body.

20. The display as set forth in claim 19, wherein said opening includes flap members each having a reinforced aperture for receiving said elongate support member.

21. The display as set forth in claim 14, further including lock means for releasably locking said elongate support member into said mounting means and accessible from an interior surface of said window.

22. The display as set forth in claim 21, further including first cooperating engagement means on said second end of said elongate support member.

23. The display as set forth in claim 22, further including second cooperating engagement means in said mounting means configured for releasable locking engagement with said first cooperating engagement means, whereby when said first cooperating engagement means and said second cooperating engagement means are engaged, unauthorized removal of said display from said window is prevented.

24. The display as set forth in claim 14, wherein said body comprises a high density foam material.

25. A rotational display, comprising:
a body for receiving indicia, said body having an elongated central section with a passage, said body having a plurality of arcuate blade members;
an elongate support member for rotatably mounting said body, said support member having a first end and a second end opposed thereto;
stop means at said first end of said support member for preventing disengagement of said body from said support member during rotation;
mounting means for mounting said support member to an automobile window;
lock means for releasably locking said elongate support member into said mounting means and accessible from an interior surface of said window;
first cooperating engagement means on said second end of said elongate support member; and
second cooperating engagement means in said mounting means configured for releasable locking engagement with said first cooperating engagement means, whereby when said first cooperating engagement means and said second cooperating engagement means are engaged, unauthorized removal of said display from said window is prevented.

26. The display as set forth in claims 25, wherein said plurality of arcuate blade members comprises a group of four individual blades.

27. The display as set in claims 26, wherein said blades are fixedly secured to said elongated central section.

28. The display as set forth in claims 26, wherein said blades are removably mounted to said elongated central section.
